(19) United States
(12) Patent Application Publication
(10) Pub. No.: US 2024/0372347 A1
(43) Pub. Date: Nov. 7, 2024

(54) WEATHERPROOF ELECTRICAL DEVICE COVER

(71) Applicant: Southwire Company, LLC, Carrollton, GA (US)

(72) Inventor: Jason Peter Thomas, Mesa, AZ (US)

(21) Appl. No.: 18/652,448

(22) Filed: May 1, 2024

Related U.S. Application Data
(60) Provisional application No. 63/499,596, filed on May 2, 2023.

(51) Int. Cl. H02G 3/08; H02G 3/14

(52) U.S. Cl. CPC H02G 3/088; H02G 3/081; H02G 3/14

(57) ABSTRACT

A weatherproof electrical device cover may be provided. The weatherproof electrical device cover may comprise a base, a lid, and a tension element. The base may comprise a keeper. The lid may be attached to the base via a hinge. The lid may comprise a tang wherein the lid is operative to hingedly close on the base. When the lid is closed on the base, the keeper may be operative to retain the tang. The tension element may be disposed between the base and the lid. The lid may be operative to slide relative to the base to compress the tension element. When the tension element is at a first compression level, the keeper may retain the tang. When the tension element is at a second compression level greater than the first compression level, the keeper may not retain the tang.

### RELATED APPLICATION

Under provisions of 35 U.S.C. § 119 (e), Applicant claims the benefit of U.S. Provisional Application No. 63/499,596 filed May 2, 2023, which is incorporated herein by reference.

### BACKGROUND

A utility box (e.g., an electrical wall switch box, an electrical wall outlet box, an electrical ceiling box, a switch box, an outlet box, an electrical box, etc.) is the container for the space behind electrical fittings such as power outlet sockets, light switches, or fixed light fixtures. Utility boxes may be designed for either surface mounting (e.g., with cabling running along the wall surface) or for embedding in the wall or skirting board. The term “flush box” is used for a mounting box that goes inside the wall, although some use the term “wall box”. Boxes for installation within timber/plasterboard walls are usually called “cavity boxes” or “plasterboard boxes”. A ceiling-mounted utility box is referred to as a “ceiling box”.

Utility boxes contain devices for input (e.g., switches) and output (e.g., sockets and fixtures), with transfer managed by junction boxes. Utility boxes may be made of metal or plastic. A utility box is made to standard dimensions and may contain embedded bushings (e.g., in standard positions) for the attachment of wiring devices (e.g., switches and sockets). Utility boxes may not include the corresponding faceplates, because the devices to be contained in the box specify the required faceplate.

### BRIEF DESCRIPTION OF THE FIGURES

The accompanying drawings, which are incorporated in and constitute a part of this disclosure, illustrate various embodiments of the present disclosure. In the drawings:

FIGS. 1A, 1B, 1C, and 1D show a weatherproof electrical device cover;

FIGS. 2A and 2B show a weatherproof electrical device cover; and

FIG. 3 illustrates an embodiment where tension element 106 comprises a coil spring.

### DETAILED DESCRIPTION

### Overview

A weatherproof electrical device cover may be provided. The weatherproof electrical device cover may comprise a base, a lid, and a tension element. The base may comprise a keeper. The lid may be attached to the base via a hinge. The lid may comprise a tang wherein the lid is operative to hingedly close on the base. When the lid is closed on the base, the keeper may be operative to retain the tang. The tension element may be disposed between the base and the lid. The lid may be operative to slide relative to the base to compress the tension element. When the tension element is at a first compression level, the keeper may retain the tang. When the tension element is at a second compression level greater than the first compression level, the keeper may not retain the tang.

Both the foregoing overview and the following example embodiments are examples and explanatory only, and should not be considered to restrict the disclosure's scope, as described and claimed. Further, features and/or variations may be provided in addition to those set forth herein. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Electrical wiring is an electrical installation of cabling and associated devices such as switches, distribution boards, sockets, and light fittings in a structure. Wiring is subject to safety standards for design and installation. Allowable wire and cable types and sizes may be specified according to the circuit operating voltage and electric current capability, with further restrictions on the environmental conditions, such as ambient temperature range, moisture levels, and exposure to sunlight and chemicals.

Associated circuit protection, control, and distribution devices within a building's wiring system may be subject to voltage, current, and functional specifications. Wiring safety codes vary by locality, country, or region. The International Electrotechnical Commission (IEC) is attempting to harmonize wiring standards among member countries, but significant variations in design and installation requirements may still exist. Wiring installation codes and regulations may be intended to protect people and property from electrical shock and fire hazards. They may be based on a model code produced by a national or international standards organization.

Building wire and cable are used in the construction of almost every commercial, industrial, and residential property. Most commonly known as branch circuit wiring in homes and businesses, these products carry electrical current to all power applications in a building or dwelling.

Utility boxes may be used to mount electrical hardware (i.e., wiring devices) comprising, but not limited to, electrical outlets and switches fed by the aforementioned building wire and cables. In some situations, the utility boxes may be mounted outdoors. When mounted outdoors, the utility boxes may be made weather resistant by providing the unity box with a weatherproof electrical device cover. For example, the weatherproof electrical device cover may allow an electrical cord's plug to plug into an outlet mounted in the utility box while keeping the utility box weather resistant when the utility box cover is closed and the electrical cord is plugged into the outlet.

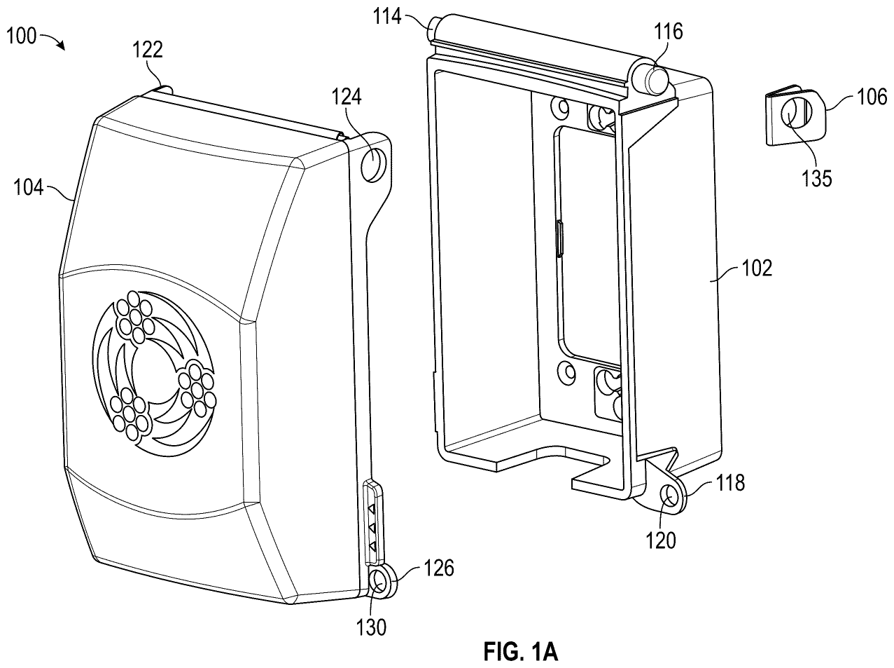

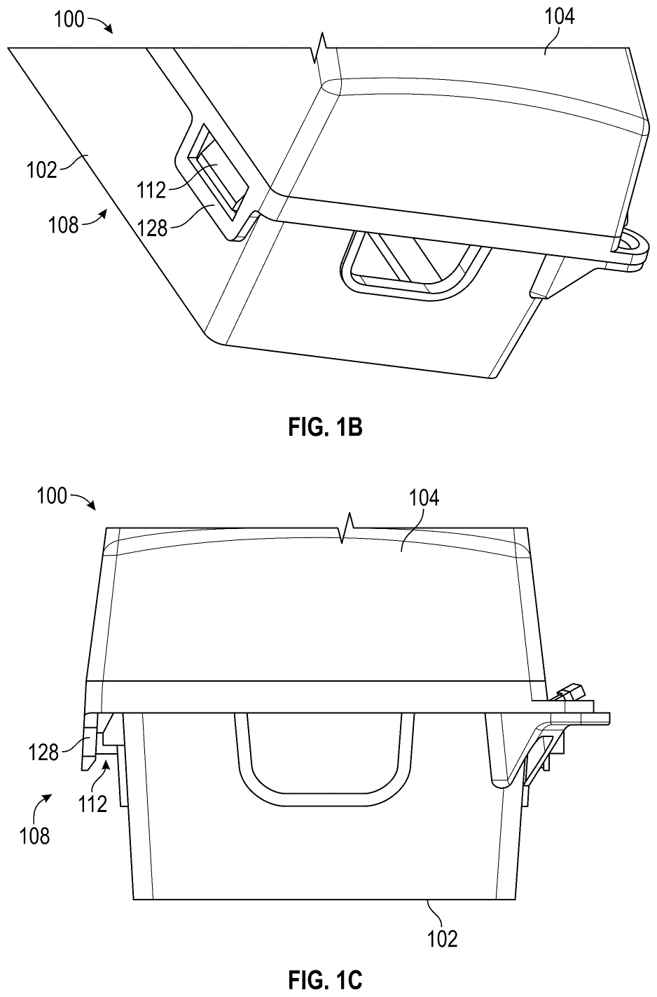

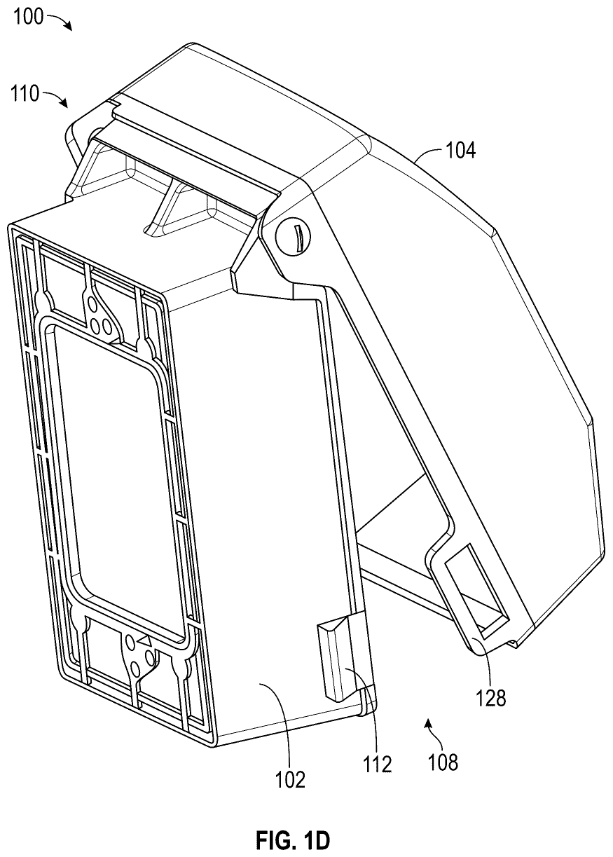

FIGS. 1A, 1B, 1C, and 1D show a weatherproof electrical device cover 100. As shown in FIGS. 1A, 1B, 1C, and 1D, weatherproof electrical device cover 100 may comprise a base 102, a lid 104, a tension element 106, a latch 108, and a hinge 110. Base 102 may comprise a keeper 112, a first hinge pin 114, a second hinge pin 116, and a first locking tab 118. First locking tab 118 may comprise a first locking tab hole 120. Lid 104 may comprise a first hinge hole 122, a second hinge hole 124, a second locking tab 126, and a tang 128. Second locking tab 126 may comprise a second locking tab hole 130. Tension element 106 may include a tension element hole 135. While FIG. 1A shows tension element 106 comprising a leaf spring (e.g., folded spring), tension element 106 is no so limited and may comprise any device capable of providing a compressive force such as a coil spring or a compressive foam washer for example.

As shown in FIGS. 1A, 1B, 1C, and 1D, base 102 may comprise keeper 112. Lid 104 may be attached to base 102 via hinge 110. Lid 104 may comprise tang 128. Lid 104 may be operative to hingedly close on base 102. When lid 104 is closed on base 102, keeper 112 may be operative to retain tang 128. Latch 108 may comprise keeper 112 and tang 128. FIG. 1B shows lid 104 closed on base 102. As shown in FIG. 1B, latch 108 may be in a locked position in which keeper 112 may be operative to retain tang 128 and thus lid 104 may be locked on base 102.

Tension element 106 may be disposed between base 102 and lid 104. As discussed in greater detail below, lid 104 may be operative to slide relative to base 102 to compress tension element 106. When tension element 106 is at a first compression level, keeper 112 may retain tang 128 and when tension element 106 is at a second compression level greater than the first compression level, keeper 112 may not retain tang 128. FIG. 1C shows lid 104 closed on base 102. As shown in FIG. 1C, lid 104 has been slid relative to base 102 thus placing latch 108 in an unlocked position in which keeper 112 may be operative to not retain tang 128 and thus lid 104 may be unlocked from base 102. As shown by FIG. 1D, with latch 108 in the unlocked position, lid 104 may be free to rotate relative to base 102 on hinge 110.

Hinge 110 may comprise first hinge pin 114 disposed on base 102 inserted in first hinge hole 122 disposed on lid 104. Hinge 110 may further comprise second hinge pin 116 disposed on base 102 inserted in second hinge hole 124 disposed on lid 104. Tension element 106 may be disposed between first hinge pin 114 with first hinge pin 114 disposed in tension element hole 135.

First locking tab hole 120 in first locking tab 118 aligns with second locking tab hole 130 in second locking tab 126 when tension element 106 is at the first compression level. However, first locking tab hole 120 in first locking tab 118 may not align with second locking tab hole 130 in second locking tab 126 when tension element 106 is at the second compression level. First locking tab hole 120 in first locking tab 118 and second locking tab hole 130 in second locking tab 126 are operative to receive a locking device when the tension element is at the first compression level. The locking device may comprise a padlock.

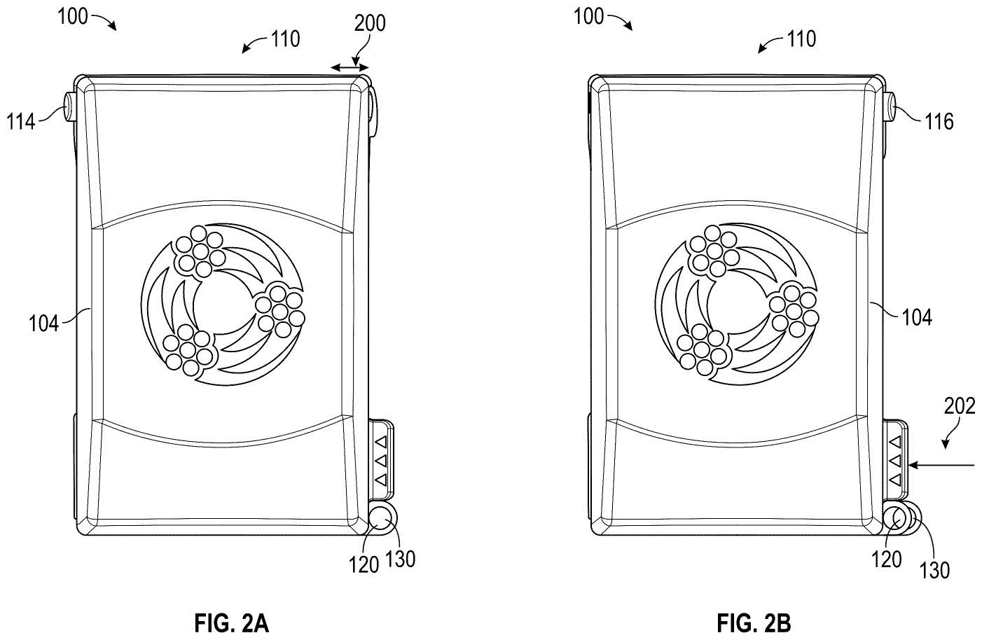

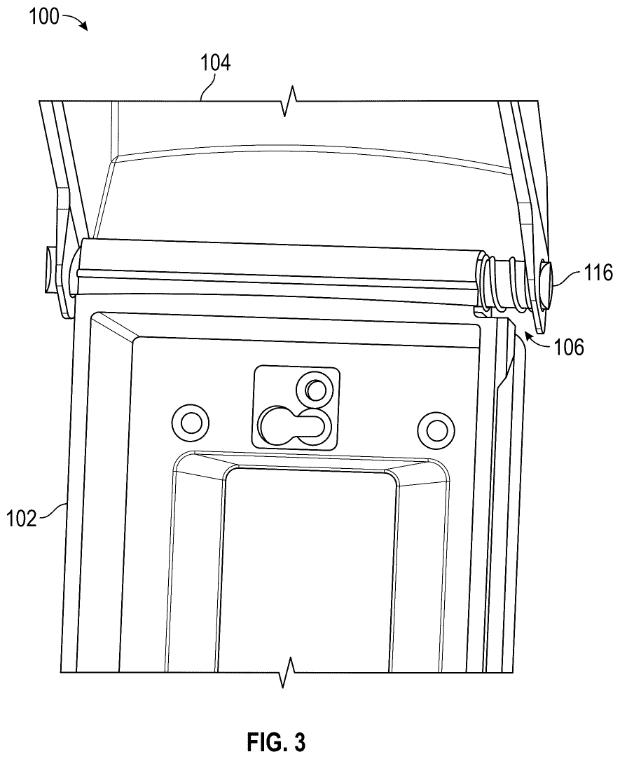

FIG. 2A shows latch 108 in the locked position with lid 104 closed on base 102. When lid 104 is closed on base 102, keeper 112 may be operative to retain tang 128. As shown in FIG. 2A (e.g., similar to FIG. 1B), latch 108 may be in the locked position in which keeper 112 may be operative to retain tang 128 and thus lid 104 may be locked on base 102. A first force 200 caused by tension element 106 at the first compression level may cause latch 108 to be in the locked state. As shown in FIG. 2A, first locking tab hole 120 in first locking tab 118 aligns with second locking tab hole 130 in second locking tab 126 when tension element 106 is at the first compression level.

FIG. 2B shows latch 108 in the unlocked position with lid 104 closed on base 102. When lid 104 is closed on base 102, but with latch 108 unlocked, keeper 112 may be operative to release tang 128. As shown in FIG. 2B (e.g., similar to FIG. 1C), latch 108 may be in the unlocked position in which keeper 112 may be operative to release tang 128 and thus lid 104 may be unlocked from base 102. A second force 202 (e.g., applied by an operator) may be opposite to counter act first force 200 causing tension element 106 to be at the second compression level that may cause latch 108 to be in the unlocked state. As shown in FIG. 2B, first locking tab hole 120 in first locking tab 118 may not align with second locking tab hole 130 in second locking tab 126 when tension element 106 is at the second compression level. With latch 108 in the unlocked position, lid 104 may be free to rotate relative to base 102 on hinge 110 (e.g., FIG. 1D).

FIG. 3 illustrates an embodiment where tension element 106 comprises a coil spring. As shown in FIG. 3, the coil spring may be placed around second hinge pin 116 and may be disposed between base 102 and lid 104.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. An apparatus comprising:
a base comprising a keeper;
a lid attached to the base via a hinge wherein the lid comprises a tang wherein the lid is operative to hingedly close on the base, wherein, when the lid is closed on the base, the keeper is operative to retain the tang; and
a tension element disposed between the base and the lid wherein the lid is operative to slide relative to the base to compress the tension element wherein when the tension element is at a first compression level, the keeper retains the tang and when the tension element is at a second compression level greater than the first compression level, the keeper does not retain the tang.

2. The apparatus of claim 1, wherein the tension element comprises a spring.

3. The apparatus of claim 1, wherein the base further comprises a first locking tab.

4. The apparatus of claim 3, wherein the lid further comprises a second locking tab.

5. The apparatus of claim 4, wherein a first locking tab hole in the first locking tab aligns with a second locking tab hole in the second locking tab when the tension element is at the first compression level.

6. The apparatus of claim 4, wherein a first locking tab hole in the first locking tab does not align with a second locking tab hole in the second locking tab when the tension element is at the second compression level.

7. The apparatus of claim 4, wherein a first locking tab hole in the first locking tab and a second locking tab hole in the second locking tab are operative to receive a locking device when the tension element is at the first compression level.

8. The apparatus of claim 7, wherein the locking device comprises a padlock.

9. The apparatus of claim 1, wherein the hinge comprises:
a first hinge pin disposed on the base inserted in a first hinge hole disposed on the lid; and
a second hinge pin disposed on the base inserted in a second hinge hole disposed on the lid.

10. The apparatus of claim 9, wherein the tension element is disposed between the first hinge pin and the first hinge hole.

11. The apparatus of claim 1, wherein the tension element comprises a folded spring.

12. An apparatus comprising:
a base comprising a keeper;
a lid attached to the base via a hinge wherein the lid comprises a tang wherein the lid is operative to hingedly close on the base, wherein, when the lid is closed on the base, the keeper is operative to retain the tang, wherein the hinge comprises:
a first hinge pin disposed on the base inserted in a first hinge hole disposed on the lid, and
a second hinge pin disposed on the base inserted in a second hinge hole disposed on the lid; and
a tension element disposed between the base and the lid wherein the lid is operative to slide relative to the base to compress the tension element wherein when the tension element is at a first compression level, the keeper retains the tang and when the tension element is at a second compression level greater than the first compression level, the keeper does not retain the tang.

13. The apparatus of claim 12, wherein the tension element is disposed between the first hinge pin and the first hinge hole.

14. The apparatus of claim 12, wherein the tension element is disposed between the second hinge pin and the second hinge hole.

15. The apparatus of claim 12, wherein the tension element comprises a spring.

16. An apparatus comprising:
a base comprising a keeper, wherein the base further comprises a first locking tab;
a lid attached to the base via a hinge wherein the lid comprises a tang wherein the lid is operative to hingedly close on the base, wherein, when the lid is closed on the base, the keeper is operative to retain the tang, wherein the lid further comprises a second locking tab; and
a tension element disposed between the base and the lid wherein the lid is operative to slide relative to the base to compress the tension element wherein when the tension element is at a first compression level, the keeper retains the tang and when the tension element is at a second compression level greater than the first compression level, the keeper does not retain the tang wherein a first locking tab hole in the first locking tab aligns with a second locking tab hole in the second locking tab when the tension element is at the first compression level and wherein the first locking tab hole in the first locking tab does not align with the second locking tab hole in the second locking tab when the tension element is at the second compression level.

17. The apparatus of claim 16, wherein the first locking tab hole in the first locking tab and the second locking tab hole in the second locking tab are operative to receive a locking device when the tension element is at the first compression level.

18. The apparatus of claim 16, wherein the hinge comprises:
a first hinge pin disposed on the base inserted in a first hinge hole disposed on the lid; and
a second hinge pin disposed on the base inserted in a second hinge hole disposed on the lid.

19. The apparatus of claim 18, wherein the tension element is disposed between the first hinge pin and the first hinge hole.

20. The apparatus of claim 1, wherein the tension element comprises a folded spring.
